(19) United States
(12) Patent Application Publication
(10) Pub. No.: US 2026/0124600 A1
(43) Pub. Date: May 7, 2026

(54) WATER-ABSORBING COMPOSITE WITH BIODEGRADABILITY AND MANUFACTURING METHOD THEREOF

(71) Applicant: National Taiwan University, Taipei City (TW)

(72) Inventors: YI-CHEN CHEN, Taipei City (TW); YU-SHAN CHANG, Taipei City (TW)

(73) Assignee: National Taiwan University, Taipei City (TW)

(21) Appl. No.: 19/023,253

(22) Filed: Jan. 15, 2025

(30) Foreign Application Priority Data
Nov. 5, 2024 (TW) 113142264

(51) Int. Cl. B01J 20/26; B01J 20/24; B01J 20/28; B01J 20/30

(52) U.S. Cl. CPC B01J 20/267; B01J 20/24; B01J 20/28047; B01J 20/3085

(57) ABSTRACT

A water-absorbing composite with a biodegradability includes an egg white composition, an acylation reagent, and a crosslinking reagent. The egg white composition contains a plurality of proteins with an amount between 3 wt % and 5 wt %. The acylation reagent reacts with a part of amines of the proteins of the egg white composition, so that the egg white composition has a plurality of hydrophilic groups. A weight ratio of the acylation reagent to the proteins is between 0.05 g/g and 0.5 g/g. The crosslinking reagent bonds to another part of amines of the proteins of the egg white composition or a part of hydroxyl groups of the proteins of the egg white composition. A weight ratio of the crosslinking reagent added to the protein solution to the proteins is between 0.1 g/g and 0.7 g/g. A manufacturing method of the water-absorbing composite with the biodegradability is also provided.

### BACKGROUND OF THE INVENTION

### Technical Field

The present invention relates generally to a water-absorbing composite, and more particularly to a water-absorbing composite with a biodegradability and a manufacturing method thereof.

### Description of Related Art

Superabsorbent polymer (SAP) plays a significant role as a water-absorbing material in a water-absorbing product. Superabsorbent polymer (SAP) is a petrochemical material and has a great water-absorbing capacity. Superabsorbent polymer (SAP) is applied to the water-absorbing product such as diaper or absorbent pad for food. In addition, it is researched that superabsorbent polymer (SAP) could be applied to an agricultural field. Because superabsorbent polymer (SAP) has a function of absorbing a liquid and slowly releasing the liquid, it is researched that superabsorbent polymer (SAP) could be a fertilizer carrier or a soil water retention agent, could reduce a moisture transpiration rate of a soil, and could raise a water-containing amount of the soil, thereby helping a plant growth.

However, because superabsorbent polymer (SAP) is the petrochemical material which could not be naturally decomposed or be reused, an abandoned water-absorbing composite product made of superabsorbent polymer (SAP) could not be effectively recycled, which causes a problem of environmental pollution. In addition, because superabsorbent polymer (SAP) applied to an agricultural irrigation could not be naturally decomposed by the soil, superabsorbent polymer (SAP) might cause the problem of environmental pollution.

In addition, abnormal eggs containing broken eggs and soft-shelled eggs might be existed during a manufacturing process of eggs. Because the abnormal eggs could not be sold on a normal market, the abnormal eggs would be directly discarded, thereby wasting protein sources and increasing a pressure to dispose egg wastes. It is researched that protein of the eggs have a great water-absorbing ability. However, how to substitute a water-absorbing material made from the abnormal eggs for superabsorbent polymer (SAP) to improve the conventional water-absorbing material without a biodegradability is a problem needed to be solved.

### BRIEF SUMMARY OF THE INVENTION

In view of the above, the primary objective of the present invention is to provide a water-absorbing composite with a biodegradability and a manufacturing method thereof. The water-absorbing composite with the biodegradability is provided with an egg white composition of a plurality of abnormal eggs, so that the water-absorbing composite with the biodegradability could be decomposed by natural creatures and has a water-absorbing function and a water-holding function. The manufacturing method of the water-absorbing composite with the biodegradability undergoes an optimized process, thereby raising a manufacturing efficiency and reducing an energy dissipation.

The present invention provides a water-absorbing composite with a biodegradability including an egg white composition, an acylation reagent, and a crosslinking reagent. The egg white composition has a plurality of proteins, wherein a weight of the proteins accounts for between 3 wt % and 5 wt % of a weight of the water-absorbing composite with the biodegradability. The acylation reagent reacts with a part of amines of the proteins of the egg white composition, so that the egg white composition has a plurality of hydrophilic groups, wherein the acylation reagent is ethylenediaminetetraacetic dianhydride or succinic anhydride. A weight ratio of the acylation reagent to the proteins is between 0.05 g/g and 0.5 g/g. The crosslinking reagent bonds to another part of the amines of the proteins of the egg white composition or a part of hydroxyl groups of the proteins of the egg white composition, wherein the crosslinking reagent is N,N′-methylenebisacrylamide or glycerol. A weight ratio of the crosslinking reagent to the proteins is between 0.1 g/g and 0.7 g/g.

The present invention further provides a manufacturing method of the water-absorbing composite with the biodegradability including the following steps: step S1: providing a protein solution, wherein the protein solution has the egg white composition including the proteins. The weight of the proteins of the egg white composition accounts for between 3 wt % and 5 wt % of the weight of the protein solution. Step S2: adding the acylation reagent to the protein solution, mixing and modulating a pH value of the protein solution to be between 8 and 12, wherein the acylation reagent is ethylenediaminetetraacetic dianhydride or succinic anhydride. The acylation reagent reacts with the part of the amines of the proteins of the egg white composition, so that the egg white composition has the hydrophilic groups. Step S3: adding the crosslinking reagent to the protein solution, mixing and then heating the crosslinking reagent and the protein solution, wherein the crosslinking reagent is N,N′-methylenebisacrylamide or glycerol. The crosslinking reagent bonds to the another part of the amines of the proteins of the egg white composition or the part of a plurality of hydroxyl groups of proteins of the egg white composition to form a protein-based hydrogel. Step S4: drying the protein-based hydrogel containing the acylation reagent and the crosslinking reagent to form a dried protein-based hydrogel, thereby obtaining the water-absorbing composite with the biodegradability.

With the aforementioned design, the water-absorbing composite with the biodegradability is provided with the egg white composition from egg whites of the abnormal eggs and the acylation reagent and the crosslinking reagent with specific categories and weight ratios, so that the water-absorbing composite with the biodegradability has the great water-absorbing function and the great water-holding function. Therefore, the water-absorbing composite with the biodegradability could substitute superabsorbent polymer (SAP) and a problem of wasting the abnormal eggs could be solved. In addition, the water-absorbing composite with the biodegradability having been used could be recycled as a fertilizer carrier or a soil water retention agent, so that the water-absorbing composite with the biodegradability is no need to be disposed as a waste, could be directly recycled for an agricultural fertilization, could be naturally discomposed in a soil, and could accelerate a plant growth.

In addition, the manufacturing method of the water-absorbing composite with the biodegradability undergoes many optimized processes to omit a preprocessing of the protein solution containing many and repeated steps of freezing. A heating process is omitted in step S2, so that a manufacturing time of the manufacturing method of the water-absorbing composite with the biodegradability is greatly reduced and the water-absorbing function of the water-absorbing composite with the biodegradability would not be affected. In this way, the manufacturing method of the water-absorbing composite with the biodegradability could raise the manufacturing efficiency and reduce the energy dissipation.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a flow chart of the manufacturing method of the water-absorbing composite with the biodegradability according to an embodiment of the present invention;

FIG. 2 is a schematic view, showing succinic anhydride with different weight ratios added to experimental groups 1˜5 corresponding to a swelling capacity of each of the experimental groups 1˜5 according to the embodiment of the present invention;

FIG. 3 is a schematic view, showing glycerol with different weight ratios added to experimental groups 6˜9 corresponding to a swelling capacity of each of the experimental groups 6˜9 according to the embodiment of the present invention;

FIG. 4 is a schematic view, showing a swelling capacity of each of experimental groups 10˜13 and a water holding capacity of each of the experimental groups 10˜13 according to the embodiment of the present invention;

FIG. 5 is a schematic view, showing a reswelling capacity of each of the experimental groups 10˜13 according to the embodiment of the present invention;

FIG. 6A is a schematic view, showing microscopic images of the experimental groups 10˜13 in a dry state according to the embodiment of the present invention;

FIG. 6B is a schematic view, showing microscopic images of the experimental groups 10˜13 in a water-absorbing state according to the embodiment of the present invention;

FIG. 7 is a schematic view, showing an absorbency under different loads of each of the experimental groups 12˜13 respectively corresponding to the swelling capacity of each of the experimental groups 12˜13 according to the embodiment of the present invention;

FIG. 8A is a schematic view, showing a cumulative release of each of the experimental groups 12˜13 according to the embodiment of the present invention;

FIG. 8B is a schematic view, showing the cumulative release of each of the experimental groups 12˜13 according to the embodiment of the present invention;

FIG. 9A is a schematic view, showing a biodegradability of each of the experimental groups 12˜13 according to the embodiment of the present invention;

FIG. 9B is a schematic view, showing images in which a bacterial growth with the experimental group 12 and the experimental group 13 decomposed by the bacteria in a soil according to the embodiment of the present invention;

FIG. 10 is a schematic view, showing a water evaporation of each of the experimental groups 12˜13 in the soil according to the embodiment of the present invention; and

FIG. 11 is a schematic view, showing a plant growth of each of the experimental groups 12˜13 according to the embodiment of the present invention.

### DETAILED DESCRIPTION OF THE INVENTION

A water-absorbing composite with a biodegradability according to an embodiment of the present invention includes an egg white composition, an acylation reagent, and a crosslinking reagent.

The egg white composition is made from egg whites of birds and has a plurality of kinds of proteins. A weight of the proteins of the egg white composition accounts for between 3 wt % and 5 wt % of a weight of the water-absorbing composite with the biodegradability. In the current embodiment, the egg white composition is made from egg whites of chickens, and the proteins of the egg white composition mainly contain ovalbumin and further contain ovotransferrin, ovomucoid, ovomucin, and globumin.

The acylation reagent reacts with a part of amines of the proteins of the egg white composition by an acylation reaction, so that the egg white composition has a plurality of hydrophilic groups, i.e., the acylation reagent could react with the proteins of the egg white composition containing ovalbumin, ovotransferrin, and ovomucoid by the acylation reaction. In the current embodiment, the acylation reagent is ethylenediaminetetraacetic dianhydride (EDTAD) or succinic anhydride (SA), and a weight ratio of the acylation reagent to the proteins of the egg white composition is between 0.05 g/g and 0.5 g/g.

The crosslinking reagent bonds to another part of the amines of the proteins of the egg white composition and a part of hydroxyl groups of the proteins of the egg white composition, so that a structural stability of the egg white composition could be enhanced and the crosslinking reagent does not react with the acylation reagent. In the current embodiment, the crosslinking reagent is N,N′-methylenebisacrylamide (MBA) or glycerol; a weight ratio of the crosslinking reagent to the proteins is between 0.1 g/g and 0.7 g/g. The different acylation reagent with the different weight ratio could cooperate with the different crosslinking reagent with the different weight ratio. When the acylation reagent is ethylenediaminetetraacetic dianhydride (EDTAD) and the crosslinking reagent is glycerol, the weight ratio of the acylation reagent to the proteins is between 0.15 g/g and 0.25 g/g and the weight ratio of the crosslinking reagent to the proteins is between 0.2 g/g and 0.7 g/g. When the acylation reagent is ethylenediaminetetraacetic dianhydride (EDTAD) and the crosslinking reagent is N,N′-methylenebisacrylamide (MBA), the weight ratio of the acylation reagent to the proteins is between 0.15 g/g and 0.25 g/g and the weight ratio of the crosslinking reagent to the proteins is between 0.1 g/g and 0.16 g/g. When the acylation reagent is succinic anhydride (SA) and the crosslinking reagent is glycerol, the weight ratio of the acylation reagent to the proteins is between 0.05 g/g and 0.5 g/g and the weight ratio of the crosslinking reagent to the proteins is between 0.2 g/g and 0.7 g/g.

The categories of the crosslinking reagent and an amount of the crosslinking reagent adding to the water-absorbing composite with the biodegradability could affect a cross-linking density of the proteins of the egg white composition. For example, when a weight ratio of glycerol to the proteins of the egg white composition is less than 0.2 g/g or a weight ratio of N,N′-methylenebisacrylamide (MBA) to the proteins of the egg white composition is less than 0.1 g/g, the cross-linking density of the proteins of the egg white composition decreases and a mechanical strength of the water-absorbing composite with the biodegradability and a water holding capacity of the water-absorbing composite with the biodegradability are correspondingly reduced, so that a shape of the water-absorbing composite with the biodegradability could not be fixed. When the weight ratio of glycerol to the proteins of the egg white composition is greater than 0.7 g/g or the weight ratio of N,N′-methylenebisacrylamide (MBA) to the proteins of the egg white composition is greater than 0.16 g/g, a plurality of pores of a mesh structure formed by the proteins of the egg white composition are greatly reduced and a swelling capacity of the water-absorbing composite with the biodegradability is reduced due to the excessively high cross-linking density of the proteins of the egg white composition.

In addition, when the crosslinking reagent is N,N′-methylenebisacrylamide (MBA), the water-absorbing composite with the biodegradability would be added with ammonium persulphate (APS) as a crosslinking initiator to induce the proteins of the egg white composition to produce a plurality of free radicals, so that N,N′-methylenebisacrylamide (MBA) bonds to the proteins of the egg white composition. In an embodiment, when the crosslinking reagent is glycerol, the water-absorbing composite with the biodegradability could be a combination of the egg white composition, the acylation reagent, and the crosslinking reagent without ammonium persulphate (APS).

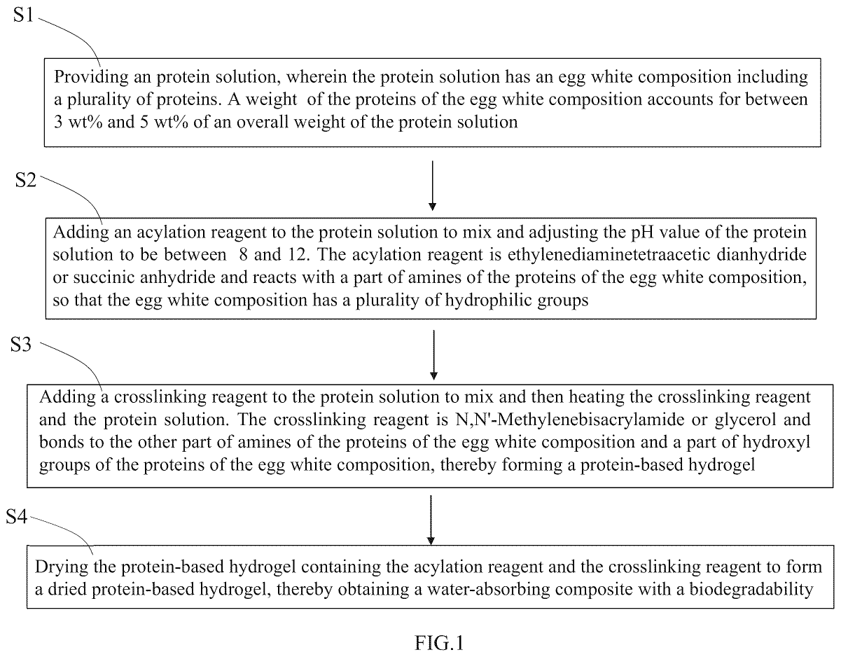

A manufacturing method of the water-absorbing composite with the biodegradability according to another embodiment of the present invention is illustrated in FIG. 1 and makes use of the acylation reagent and the crosslinking reagent. The manufacturing method of the water-absorbing composite with the biodegradability includes the following steps:

Step S1: a protein solution is provided and has the proteins of the egg white composition. The weight of the proteins of the egg white composition accounts for between 3 wt % and 5 wt % of a weight of the protein solution. If the weight of the proteins of the egg white composition accounts for greater than 5 wt % of the weight of the protein solution, the egg white composition might be poorly soluble in the protein solution. If the weight of the proteins of the egg white composition accounts for less than 3 wt % of the weight of the protein solution, an amount of the egg white composition would be too low to achieve an expected chemical reaction and a water-absorbing effect.

In the current embodiment, step P1 could be executed before step S1. An egg white liquid is provided and includes the egg white composition. The egg white liquid is made into an egg white powder by freeze-drying and the egg white powder is dissolved in an aqueous solution to form the protein solution. The egg white liquid is an egg white liquid coming from a plurality of abnormal eggs being recycled or an excess egg white liquid in the market. The egg white liquid is executed by freeze-drying once after pasteurization to form the egg white powder. In other embodiments, the egg white liquid could be dried by spray drying or hot air drying to form the egg white powder. Alternatively, step P1 could be omitted in the manufacturing method of the water-absorbing composite with the biodegradability and the egg white powder could be bought to formulate the protein solution.

Step S2: the acylation reagent is added to the protein solution and the acylation reagent and the protein solution are mixed. The acylation reagent is ethylenediaminetetraacetic dianhydride (EDTAD) or succinic anhydride (SA). The weight ratio of the acylation reagent adding to the protein solution to the proteins of the egg white composition is between 0.05 g/g and 0.5 g/g and a pH value of the protein solution is modulated to be between 8 and 12. A stirring time of the protein solution is between 2 and 3 hours. The pH value of the protein solution is modulated according to the categories of the acylation reagent added to the protein solution. For example, when the acylation reagent is ethylenediaminetetraacetic dianhydride (EDTAD) and is added to the protein solution, the pH value of the protein solution is modulated to be 12 by adding a 10N NaOH solution the protein solution. When the acylation reagent is succinic anhydride (SA) and is added to the protein solution, the pH value of the protein solution is modulated to be 8 by adding the 10N NaOH solution to the protein solution.

It is researched that the proteins of the egg white composition of the protein solution could undergo a denaturation reaction in an alkaline environment (high pH value), so that the proteins of the egg white composition turn from a quaternary structure or a tertiary structure into a secondary structure or a primary structure and produces numerous free amines which are sufficient for the acylation reagent to react with the proteins of the egg white composition. Therefore, in the current embodiment, the acylation reagent is added to the protein solution at room temperature to omit a preheating process of the protein solution, thereby simplifying a manufacturing process and reducing an energy cost.

Step S3: the crosslinking reagent is added to the protein solution and the crosslinking reagent is mixed with the protein solution. The crosslinking reagent is N,N′-methylenebisacrylamide (MBA) or glycerol. The weight ratio of the crosslinking reagent added to the protein solution to the proteins of the egg white composition is between 0.1 g/g and 0.7 g/g. The crosslinking reagent is stirred for between 10 and 20 minutes in the protein solution and then is heated to be gelatinous, so that the crosslinking reagent bonds to the another part of the amines of the proteins of the egg white composition or the part of hydroxyl groups of the proteins of the egg white composition to form the mesh structure and produce a protein-based hydrogel.

Step S4: the protein-based hydrogel containing the acylation reagent and the crosslinking reagent is dried to form a dried protein-based hydrogel. The protein-based hydrogel is dried at a temperature of between 50° C. and 60° C. for between 24 and 48 hours to form the water-absorbing composite with the biodegradability, i.e., the dried protein-based hydrogel.

In order to thoroughly illustrate the primary objective, features, and functions of the present invention, the water-absorbing composite with the biodegradability of the current embodiment having the egg white composition combined with different amounts of different acylation reagents and different amounts of different crosslinking reagents are examined with respect to the swelling capacity, the water-holding capacity, a biocompatibility, a release of urea, a soil water evaporation, and a plant growth, thereby illustrating that the water-absorbing composite with the biodegradability of the current embodiment has the swelling capacity and the biodegradability.

The embodiments described below could further prove the scope of the present invention. All parameters or settings disclosed in this specification and the appended claims could be properly adjusted, which should still fall within the scope of the present invention.

1. It is Explored that the Acylation Reagent is Succinic Anhydride (SA) and the Swelling Capacity of the Water-Absorbing Composite with the Biodegradability Corresponds To Succinic Anhydride (SA) with Different Amounts:

Control group 1: the weight of the proteins of the egg white composition accounts for 4 wt % of the weight of the protein solution. A weight of the aqueous solution accounts for 96 wt % of the weight of the protein solution. The crosslinking reagent is N,N′-methylenebisacrylamide (MBA). The weight ratio of the crosslinking reagent (MBA) to the proteins of the egg white composition is 0.13 g/g and the crosslinking reagent (MBA) is added to the protein solution. A weight ratio of ammonium persulphate (APS) as the crosslinking initiator to the proteins of the egg white composition is 0.062 g/g and ammonium persulphate (APS) is added to the protein solution. The control group 1 is provided without the acylation reagent (SA).

Experimental group 1: the weight of the proteins of the egg white composition accounts for 4 wt % of the weight of the protein solution. The weight of the aqueous solution accounts for 96 wt % of the weight of the protein solution. The crosslinking reagent is N,N′-methylenebisacrylamide (MBA). The weight ratio of the crosslinking reagent (MBA) to the proteins of the egg white composition is 0.13 g/g and the crosslinking reagent (MBA) is added to the protein solution. A weight ratio of ammonium persulphate (APS) as the crosslinking initiator to the proteins of the egg white composition is 0.062 g/g and ammonium persulphate (APS) is added to the protein solution. The acylation reagent is succinic anhydride (SA). The weight ratio of the acylation reagent (SA) to the proteins of the egg white composition is 0.05 g/g and the acylation reagent (SA) is added to the protein solution.

Experimental group 2: the weight of the proteins of the egg white composition accounts for 4 wt % of the weight of the protein solution. The weight of the aqueous solution accounts for 96 wt % of the weight of the protein solution. The crosslinking reagent is N,N′-methylenebisacrylamide (MBA). The weight ratio of the crosslinking reagent (MBA) to the proteins of the egg white composition is 0.13 g/g and the crosslinking reagent (MBA) is added to the protein solution. The weight ratio of ammonium persulphate (APS) as the crosslinking initiator to the proteins of the egg white composition is 0.062 g/g and ammonium persulphate (APS) is added to the protein solution. The acylation reagent is succinic anhydride (SA). The weight ratio of the acylation reagent (SA) to the proteins of the egg white composition is 0.10 g/g and the acylation reagent (SA) is added to the protein solution.

Experimental group 3: the weight of the proteins of the egg white composition accounts for 4 wt % of the weight of the protein solution. The weight of the aqueous solution accounts for 96 wt % of the weight of the protein solution. The crosslinking reagent is N,N′-methylenebisacrylamide (MBA). The weight ratio of the crosslinking reagent (MBA) to the proteins of the egg white composition is 0.13 g/g and the crosslinking reagent (MBA) is added to the protein solution. The weight ratio of ammonium persulphate (APS) as the crosslinking initiator to the proteins of the egg white composition is 0.062 g/g and ammonium persulphate (APS) is added to the protein solution. The acylation reagent is succinic anhydride (SA). The weight ratio of the acylation reagent (SA) to the proteins of the egg white composition is 0.15 g/g and the acylation reagent (SA) is added to the protein solution.

Experimental group 4: the weight of the proteins of the egg white composition accounts for 4 wt % of the weight of the protein solution. The weight of the aqueous solution accounts for 96 wt % of the weight of the protein solution. The crosslinking reagent is N,N′-methylenebisacrylamide (MBA). The weight ratio of the crosslinking reagent (MBA) to the proteins of the egg white composition is 0.13 g/g and the crosslinking reagent (MBA) is added to the protein solution. The weight ratio of ammonium persulphate (APS) as the crosslinking initiator to the proteins of the egg white composition is 0.062 g/g and ammonium persulphate (APS) is added to the protein solution. The acylation reagent is succinic anhydride (SA). The weight ratio of the acylation reagent (SA) to the proteins of the egg white composition is 0.20 g/g and the acylation reagent (SA) is added to the protein solution.

Experimental group 5: the weight of the proteins of the egg white composition accounts for 4 wt % of the weight of the protein solution. The weight of the aqueous solution accounts for 96 wt % of the weight of the protein solution. The crosslinking reagent is N,N′-methylenebisacrylamide (MBA). The weight ratio of the crosslinking reagent (MBA) to the proteins of the egg white composition is 0.13 g/g and the crosslinking reagent (MBA) is added to the protein solution. The weight ratio of ammonium persulphate (APS) as the crosslinking initiator to the proteins of the egg white composition is 0.062 g/g and ammonium persulphate (APS) is added to the protein solution. The acylation reagent is succinic anhydride (SA). The weight ratio of the acylation reagent (SA) to the proteins of the egg white composition is 0.40 g/g and the acylation reagent (SA) is added to the protein solution.

### Swelling Capacity Test (Equilibrium Swelling):

The swelling capacity test is that the control group 1 and the experimental groups 1˜5 are dried to form the dried protein-based hydrogel beforehand. Subsequently, the control group 1 and the experimental groups 1˜5 are respectively weighed (W1) and then are respectively placed in a plurality of dry tea bags. Subsequently, the tea bags containing the dried protein-based hydrogels and an empty tea bag are placed in a 100 ml beaker and soaked in the water. After the tea bag of the control group 1 and the tea bags of the experimental groups 1˜5 are soaked in the water 24 hours, droplets on a surface of each of the tea bags are softly wiped out by using a lens paper and then the tea bags are weighed (W2). At the same time, the empty tea bag having been soaked in the water is weighed (W3); W1, W2, and W3 are substituted into the following equation to obtain an equilibrium swelling capacity of the control group 1 and an equilibrium swelling capacity of the experimental groups 1˜5.

$$Swelling capacity ( g / g ) = ( W 2 - W 3 - W 1 ) / W 1$$

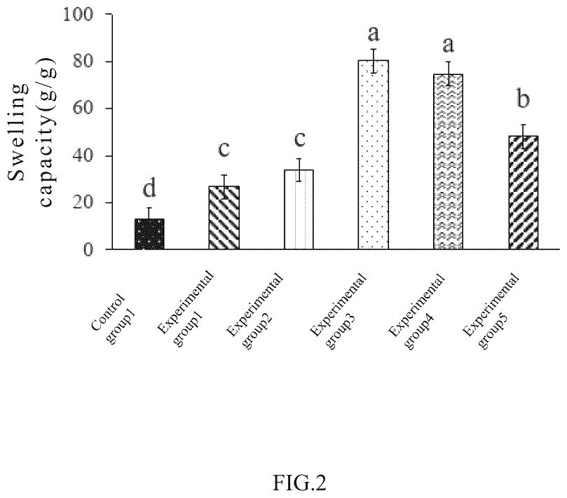

FIG. 2 shows a swelling capacity of the control group 1 and a swelling capacity of each of the experimental groups 1˜5. The swelling capacity of the experimental group 3 and the swelling capacity of the experimental group 4 are respectively better than the swelling capacity of the control group 1. The swelling capacity of the experimental group 3 is the greatest. Therefore, the weight of succinic anhydride (SA) accounting for between 0.15 g/g and 0.2 g/g of the weight of the proteins of the egg white composition could achieve the great swelling capacity.

2. It is Explored that the Crosslinking Reagent is Glycerol and the Swelling Capacity of the Water-Absorbing Composite with the Biodegradability Corresponds to Glycerol With Different Amounts:

Control group 2: the weight of the proteins of the egg white composition accounts for 4 wt % of the weight of the protein solution. The weight of the aqueous solution accounts for 96 wt % of the weight of the protein solution. The acylation reagent is ethylenediaminetetraacetic dianhydride (EDTAD). The weight ratio of the acylation reagent (EDTAD) to the proteins of the egg white composition is 0.2 g/g and the acylation reagent (EDTAD) is added to the protein solution. The control group 2 is provided without the crosslinking reagent (glycerol).

Experimental group 6: the weight of the proteins of the egg white composition accounts for 4 wt % of the weight of the protein solution. The weight of the aqueous solution accounts for 96 wt % of the weight of the protein solution. The acylation reagent is ethylenediaminetetraacetic dianhydride (EDTAD). The weight ratio of the acylation reagent (EDTAD) to the proteins of the egg white composition is 0.2 g/g and the acylation reagent (EDTAD) is added to the protein solution. The crosslinking reagent is glycerol. The weight ratio of the crosslinking reagent (glycerol) to the proteins of the egg white composition is 0.3 g/g and the crosslinking reagent (glycerol) is added to the protein solution.

Experimental group 7: the weight of the proteins of the egg white composition accounts for 4 wt % of the weight of the protein solution. The weight of the aqueous solution accounts for 96 wt % of the weight of the protein solution. The acylation reagent is ethylenediaminetetraacetic dianhydride (EDTAD). The weight ratio of the acylation reagent (EDTAD) to the proteins of the egg white composition is 0.2 g/g and the acylation reagent (EDTAD) is added to the protein solution. The crosslinking reagent is glycerol. The weight ratio of the crosslinking reagent (glycerol) to the proteins of the egg white composition is 0.4 g/g and the crosslinking reagent (glycerol) is added to the protein solution.

Experimental group 8: the weight of the proteins of the egg white composition accounts for 4 wt % of the weight of the protein solution. The weight of the aqueous solution accounts for 96 wt % of the weight of the protein solution. The acylation reagent is ethylenediaminetetraacetic dianhydride (EDTAD). The weight ratio of the acylation reagent (EDTAD) to the proteins of the egg white composition is 0.2 g/g and the acylation reagent (EDTAD) is added to the protein solution. The crosslinking reagent is glycerol. The weight ratio of the crosslinking reagent (glycerol) to the proteins of the egg white composition is 0.5 g/g and the crosslinking reagent (glycerol) is added to the protein solution.

Experimental group 9: the weight of the proteins of the egg white composition accounts for 4 wt % of the weight of the protein solution. The weight of the aqueous solution accounts for 96 wt % of the weight of the protein solution. The acylation reagent is ethylenediaminetetraacetic dianhydride (EDTAD). The weight ratio of the acylation reagent (EDTAD) to the proteins of the egg white composition is 0.2 g/g and the acylation reagent (EDTAD) is added to the protein solution. The crosslinking reagent is glycerol. The weight ratio of the crosslinking reagent (glycerol) to the proteins of the egg white composition is 0.6 g/g of the weight of the proteins of the egg white composition and the crosslinking reagent (glycerol) is added to the protein solution.

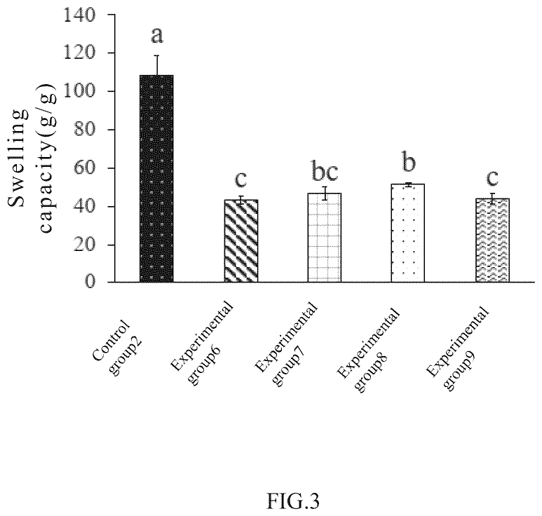

FIG. 3 shows a swelling capacity of the control group 2 and a swelling capacity of each of the experimental groups 6˜9. Compared with the swelling capacity of each of the experimental groups 6˜9 being between 40 g/g and 60 g/g, the swelling capacity of the control group 2 is the greatest, but the control group 2 is not added with the crosslinking reagent (glycerol), so that a water-absorbing structure of the control group 2 is loose and is poor at maintaining a moisture absorbed. The difference between the swelling capacity of the experimental group 8 and the swelling capacity of the control group 2 is the least. Therefore, the weight ratio of glycerol to the proteins of the egg white composition being between 0.4 g/g and 0.5 g/g could achieve the great swelling capacity and the excess weight ratio of glycerol added would indeed reduce the swelling capacity of the water-absorbing composite with the biodegradability.

3. It is Explored that the Different Combinations of the Acylation Reagent and The Crosslinking Reagent Corresponds to the Swelling Capacity of the Water-Absorbing Composite with the Biodegradability and the Water Holding Capacity of the Water-Absorbing Composite with the Biodegradability:

Control group 3: the weight of the proteins of the egg white composition accounts for 4 wt % of the weight of the protein solution. The weight of the aqueous solution accounts for 96 wt % of the weight of the protein solution. The control group 3 is provided without the acylation reagent and the crosslinking reagent and only underwent an alkaline treatment of the proteins and a heat treatment.

Experimental group 10: the weight of the proteins of the egg white composition accounts for 4 wt % of the weight of the protein solution. The weight of the aqueous solution accounts for 96 wt % of the weight of the protein solution. The acylation reagent is ethylenediaminetetraacetic dianhydride (EDTAD). The weight ratio of the acylation reagent (EDTAD) to the proteins of the egg white composition is 0.2 g/g and the acylation reagent (EDTAD) is added to the protein solution. The crosslinking reagent is N,N′-methylenebisacrylamide (MBA). The weight ratio of the crosslinking reagent (MBA) to the proteins of the egg white composition is 0.13 g/g and the crosslinking reagent (MBA) is added to the protein solution. The weight ratio of ammonium persulphate (APS), which serves as the crosslinking initiator, to the proteins of the egg white composition is 0.062 g/g and ammonium persulphate (APS) is added to the protein solution.

Experimental group 11: the weight of the proteins of the egg white composition accounts for 4 wt % of the weight of the protein solution. The weight of the aqueous solution accounts for 96 wt % of the weight of the protein solution. The acylation reagent is succinic anhydride (SA). The weight ratio of acylation reagent (SA) to the proteins of the egg white composition is 0.15 g/g and the acylation reagent (SA) is added to the protein solution. The crosslinking reagent is N,N′-methylenebisacrylamide (MBA). The weight ratio of the crosslinking reagent (MBA) to the proteins of the egg white composition is 0.13 g/g and the crosslinking reagent (MBA) is added to the protein solution. The weight ratio of ammonium persulphate (APS) as the crosslinking initiator to the proteins of the egg white composition is 0.062 g/g and ammonium persulphate (APS) is added to the protein solution.

Experimental group 12: the weight of the proteins of the egg white composition accounts for 4 wt % of the weight of the protein solution. The weight of the aqueous solution accounts for 96 wt % of the weight of the protein solution. The acylation reagent is succinic anhydride (SA). The weight ratio of the acylation reagent (SA) to the proteins of the egg white composition is 0.15 g/g of the weight of the proteins of the egg white composition and the acylation reagent (SA) is added to the protein solution. The crosslinking reagent is glycerol. The weight ratio of the crosslinking reagent (glycerol) to the proteins of the egg white composition is 0.5 g/g and the crosslinking reagent (glycerol) is added to the protein solution.

Experimental group 13: the weight of the proteins of the egg white composition accounts for 4 wt % of the weight of the protein solution. The weight of the aqueous solution accounts for 96 wt % of the weight of the protein solution. The acylation reagent is ethylenediaminetetraacetic dianhydride (EDTAD). The weight ratio of the acylation reagent (EDTAD) to the proteins of the egg white composition is 0.2 g/g and the acylation reagent (EDTAD) is added to the protein solution. The crosslinking reagent is glycerol. The weight ratio of the crosslinking reagent (glycerol) to the proteins of the egg white composition is 0.5 g/g and the crosslinking reagent (glycerol) is added to the protein solution.

### Water Holding Capacity Test:

Because the moisture absorbed by the water-absorbing composite with the biodegradability is a free water, a semi-bound water, or a bound water, the water holding capacity of the water-absorbing composite with the biodegradability is estimated by using a centrifugal force, so that a ratio of the free water of the moisture absorbed to the bound water of the moisture absorbed and a structural stability of the water-absorbing composite with the biodegradability are presumed. The control group 3 and the experimental groups 10˜13 are first dried to form the dried protein-based hydrogel. The dried protein-based hydrogel of the control group 3 and the dried protein-based hydrogel of the experimental groups 10˜13 are respectively weighed (W1) and then are placed in a plurality of dry tea bags to be soaked in the water. After the tea bag of the control group 3 and the tea bags of the experimental groups 10˜13 are soaked in the water for 24 hours, the droplets on the surface of each of the tea bags are softly wiped out by using a lens paper and then the tea bag of the control group 3 and the tea bags of the experimental groups 10˜13 are placed in a 50 ml centrifuge tube of a centrifuge (Model 3700, KUBOTA Co.) at 4° C. and are centrifuged at 300 g for 3 minutes. After the control group 3, the experimental groups 10˜13, and the empty tea bag are centrifuged, the control group 3 and the experimental groups 10˜13 are respectively weighed (W4) and the empty tea bag is weighed (W5). W1, W4, and W5 are substituted into the following equation to obtain a centrifugation retention capacity of the control group 3 and a centrifugation retention capacity of each of the experimental groups 10˜13.

$$Centrifugation retention capacity ( g / g ) = ( W 4 - W 5 - W 1 ) / W 1$$

Subsequently, the centrifugation retention capacity and the swelling capacity of the control group 3 and the centrifugation retention capacity and the swelling capacity of each of the experimental groups 10˜13 are substituted into the following equation to obtain a water holding capacity.

$$Water holding capacity ( \% ) = ( Centrifugation retention capacity / swelling capacity ) * 100 \%$$

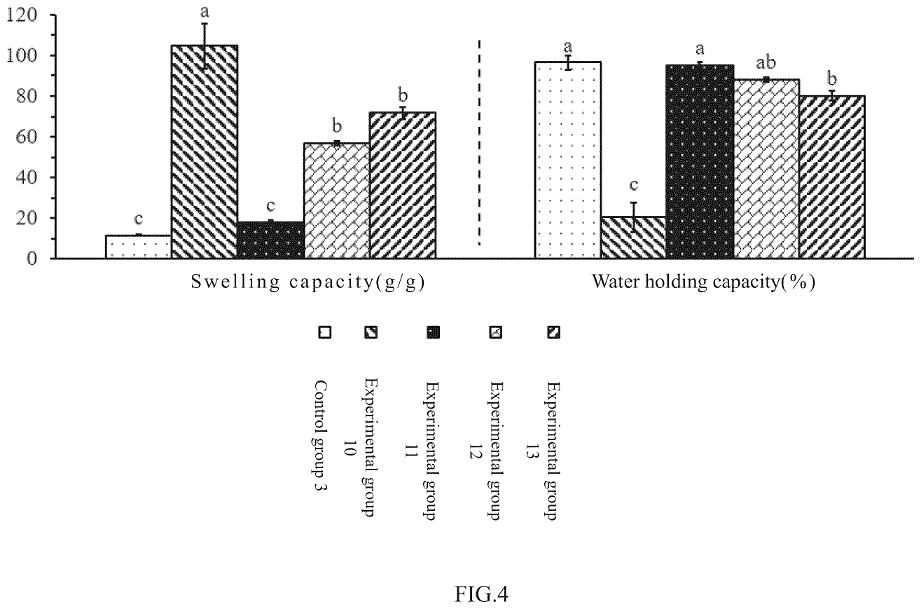

FIG. 4 shows a swelling capacity of the control group 3, a swelling capacity of each of the experimental groups 10˜13, a water holding capacity of the control group 3, and a water holding capacity of each of the experimental groups 10˜13. The swelling capacity of the experimental groups 10˜13 is greater than the swelling capacity of the control group 3. The swelling capacity of the experimental group 10 is the greatest and the swelling capacity of the experimental group 11 is almost the same as the swelling capacity of the control group 3. In addition, the control group 3 and the experimental groups 11˜13 all have the great water holding capacity, while the water holding capacity of the experimental group 10 is the least. It could be presumed from the water holding capacity test that the swelling capacity of the control group 3 and the swelling capacity of the experimental group 11 is less, so that a weight difference between the centrifuged control group 3 and the control group 3 having not been centrifuged is less and a weight difference between the centrifuged experimental group 11 and the experimental group 11 without being centrifuged is less. Therefore, the water holding capacity of the control group 3 and the water holding capacity of the experimental group 11 is greater. The crosslinking reagent of the experimental group 12 and the crosslinking reagent of the experimental group 13 are glycerol to raise a structural elasticity of the experimental group 12 and a structural elasticity of the experimental group 13, thereby raising the water holding capacity of the experimental group 12 and the water holding capacity of the experimental group 13. Because the water-absorbing capacity of the experimental group 10 might be too high, it is hard to maintain a stable structure of the experimental group 10 and the moisture could not be effectively held, so that a water holding effect of the experimental group 10 is poor.

### 4. a Reswelling Capacity of Each of the Experimental Groups 10˜13 is Explored:

The test of the reswelling capacity is provided with an I1 phase, an I2 phase, and an I3 phase. An II phase is set between the I1 phase and the I2 phase and an II phase is set between the I2 phase and the I3 phase. The control group 3 and the experimental groups 10˜13 are respectively placed in the aqueous solution in the I1 phase, the I2 phase, and the I3 phase. The control group 3 and the experimental groups 10˜13 are respectively placed in a 0.15N saline solution to be dehydrated in the II phase. The control group 3 and the experimental groups 10˜13 undergo the test of the reswelling capacity in order of the I1 phase, the II phase, the I2 phase, the II phase, and the I3 phase. The swelling capacity of the control group 3 and the swelling capacity of each of the experimental groups 10˜13 are respectively measured in the I1 phase, the I2 phase, and the I3 phase.

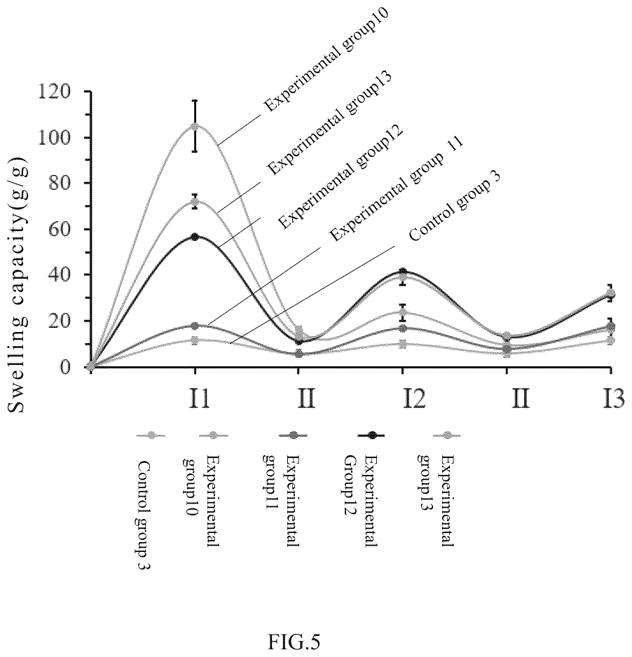

FIG. 5 shows a reswelling capacity of the control group 3 and a reswelling capacity of each of the experimental groups 10˜13. A water-absorbing amount of the control group 3 and a water-absorbing amount of the experimental group 11 are obviously less than a water-absorbing amount of the experimental groups 10,12,13 in the I1 phase. After the control group 3 and the experimental group 11 are respectively dehydrated in the II phase and then undergo in the I2 phase and the I3 phase, the reswelling capacity of the control group 3 and the reswelling capacity of the experimental group 11 are almost the same, which represents that the reswelling capacity of the control group 3 and the reswelling capacity of the experimental group 11 are obviously less than the reswelling capacity of the experimental groups 10,12,13. The water-absorbing amount of the experimental group 10 is obviously greater than the water-absorbing amount of the control group 3 and the water-absorbing amount of the experimental groups 11˜13. However, the reswelling capacity of the experimental group 10 obviously decreases after the experimental group 10 is dehydrated in the II phase and then undergoes in the I2 phase and the I3 phase. The reswelling amount of the experimental group 10 in the I3 phase is almost the same as the reswelling amount of the experimental group 10 in the I2 phase. The water-absorbing amount of the experimental group 12 and the water-absorbing amount of the experimental group 13 are obviously greater than the water-absorbing amount of the control group 3 in the I1 phase. The reswelling capacity of the experimental group 12 and the reswelling capacity of the experimental group 13 show a downward tendency after the experimental group 12 and the experimental group 13 are dehydrated in the II phase and then undergo in the I2 phase and the I3 phase. However, the reswelling capacity of the experimental group 12 and the reswelling capacity of the experimental group 13 are greater than the reswelling capacity of the control group 3 and the reswelling capacity of the experimental groups 10, 11 in the I2 phase and the I3 phase.

It could be presumed from the test of the reswelling capacity that a plurality of hydrogen bonds is formed between glycerol and the proteins of the egg white composition by a plurality of alcohol groups in the experimental group 12 and the experimental group 13 to maintain a stable structure of between glycerol and the proteins of the egg white composition. Because an energy of each of the hydrogen bonds is less, a structural elasticity of the experimental group 12 and a structural elasticity of the experimental group 13 are greater. Even if the experimental group 12 and the experimental group 13 have undergone the dehydration test for many times, a basic water-absorbing ability of each of the experimental groups 12, 13 and a basic water-holding ability of each of the experimental groups 12, 13 could be maintained. Because ethylenediaminetetraacetic dianhydride (EDTAD) competes with N,N′-methylenebisacrylamide (MBA) for an amine binding site of the proteins in the experimental group 10, a number of a plurality of covalent bonds between N,N′-methylenebisacrylamide (MBA) and the proteins of the egg white composition decreases, thereby reducing a structural stability of the experimental group 10. Even if the swelling capacity of the experimental group 10 is great in the I1 phase, the water holding capacity of the experimental group 10 is less and the experimental group 10 could not achieve the great reswelling capacity.

### 5. a Microstructure Change of the Experimental Groups 10˜13 is Explored:

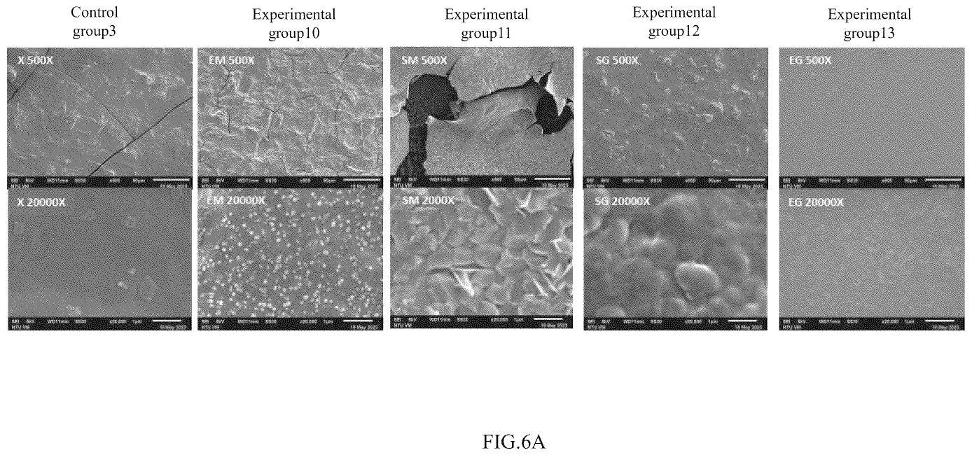

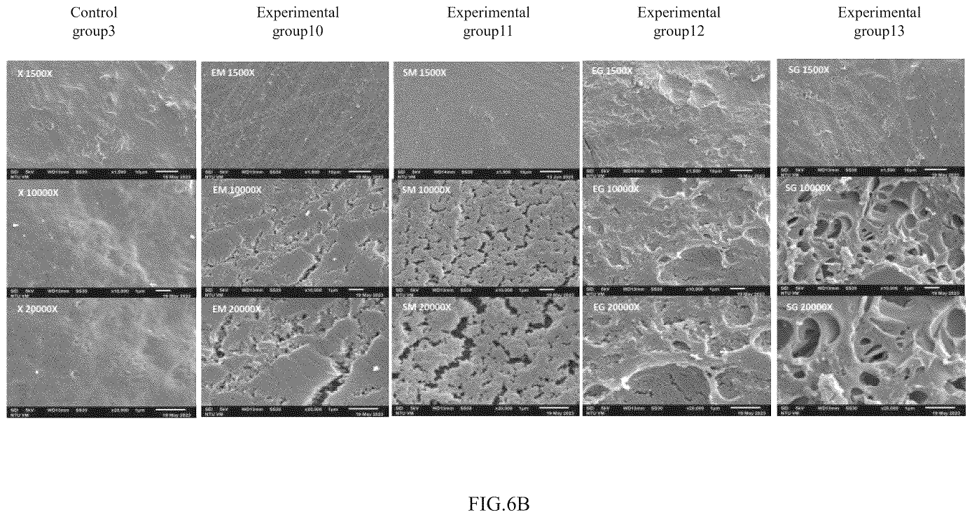

The control group 3 and the experimental groups 10˜13 are respectively measured by a scanning electron microscope (JSM-6510LV, JEOL Ltd.) to observe a structural change before and after the control group 3 and the experimental groups 10˜13 absorbs the water and the aforementioned structural change is shown in FIG. 6A and FIG. 6B.

Referring to FIG. 6A, a dry state of the control group 3 is observed at a magnification of 500 and 20000, which shows that a surface structure of the control group 3 is even without any crack. A dry state of the experimental group 10 and a dry state of the experimental group 11 are respectively observed at the magnification of 500 and 20000, which shows obvious cracks in the experimental group 10 and in the experimental group 11 and an uneven surface of the experimental group 10 and an uneven surface of the experimental group 11. It could be presumed that using N,N′-methylenebisacrylamide (MBA) as the crosslinking reagent is prone to cause a break of the water-absorbing composite with the biodegradability in a dry state. A dry state of the experimental group 12 and a dry state of the experimental group 13 are respectively observed at the magnification of 500 and 20000, which shows that a surface structure of the experimental group 12 and a surface structure of the experimental group 13 are even without any obvious crack. It could be observed at the magnification of 2000 that nanoscale pores exist in the experimental group 12 and the experimental group 13, which is helpful to quickly absorb a liquid by a capillary action.

Referring to FIG. 6B, a water-absorbing state of the control group 3 is observed at a magnification of 1500, 10000, and 20000, which shows the surface of the control group 3 is even without any crack. Therefore, it could be observed that the less moisture enters the control group 3 and the surface structure of the control group 3 is not broken, so that a water-absorbing ability of the control group 3 is poor. A water-absorbing state of the experimental group 10 and a water-absorbing state of the experimental group 11 are observed at the magnification of 1500, 10000, and 20000, which shows that obvious cracks exist on the surface of the experimental group 10 and on the surface of the experimental group 11. Therefore, the experimental group 10 and the experimental group 11 are poor at holding the moisture. Even if the experimental group 10 has the great water-absorbing capacity, the experimental group 10 quickly loses the moisture at the same time. A water-absorbing state of the experimental group 12 and a water-absorbing state of the experimental group 13 are observed at the magnification of 1500, 10000, and 20000, which obviously shows the many pores exist on the surface of the experimental group 12 and on the experimental group 13 and it could be observed at the magnification of 10000 and 20000 that the mesh structure exists in the experimental group 12 and the experimental group 13, so that the experimental group 12 and the experimental group 13 have many spaces for storing the moisture and a network crosslinking structure (i.e. the mesh structure) of the experimental group 12, a network crosslinking structure (i.e. the mesh structure) of the experimental group 13 could resist an external stress, and the water holding capacity of the experimental group 12 and the water holding capacity of the experimental group 13 could be raised.

### 6. An Absorbency Under Load of the Experimental Group 12 and an Absorbency Under Load of the Experimental Group 13 are Explored:

The experimental group 12 and the experimental group 13 is examined by an absorbency under load test to simulate a condition that the experimental group 12 and the experimental group 13 are applied to a hygiene product (e.g., diaper, sanitary towel) and a food packaging material (e.g., absorbent pad) and are subjected to a stress produced during a user or a food sitting on, lying on, or being in contact with the hygiene product and the food packaging material. The control group 4 is a commercial product (water beads, sodium polyacrylate compound) in the absorbency under load test to simulate a water-absorbing material which is typically made of sodium polyacrylate (SPA). A swelling capacity of the control group 4, the swelling capacity of the experimental group 12, and the swelling capacity of the experimental group 13 are respectively examined under different loads and a structural stability of the control group 4, a structural stability of the experimental group 12, and a structural stability of the experimental group 13 are observed.

In the absorbency under load test, a dried protein-based hydrogel of the control group 4, the dried protein-based hydrogel of the experimental group 12, and the dried protein-based hydrogel of the experimental group 13 are respectively weighed (W1) and then are respectively placed in a plurality of dry tea bags. Subsequently, the tea bags and an empty tea bag are respectively placed on a plurality of empty petri dishes, then weights with different weights (0.3 psi and 0.6 psi) are put on the tea bags, and then a 0.9% saline is added to the petri dishes. After 1 hour, the droplets on the surface of each of the tea bags are softly wiped out by using a lens paper, then the tea bags are respectively weighed (W2), and the empty tea bag is weighed (W3). W1, W2, and W3 are substituted into the following equation to obtain an equilibrium swelling capacity of the control group 4, an equilibrium swelling capacity of experimental group 12, and an equilibrium swelling capacity of experimental group 13.

$$Swelling capacity ( g / g ) = ( W 2 - W 3 - W 1 ) / W 1$$

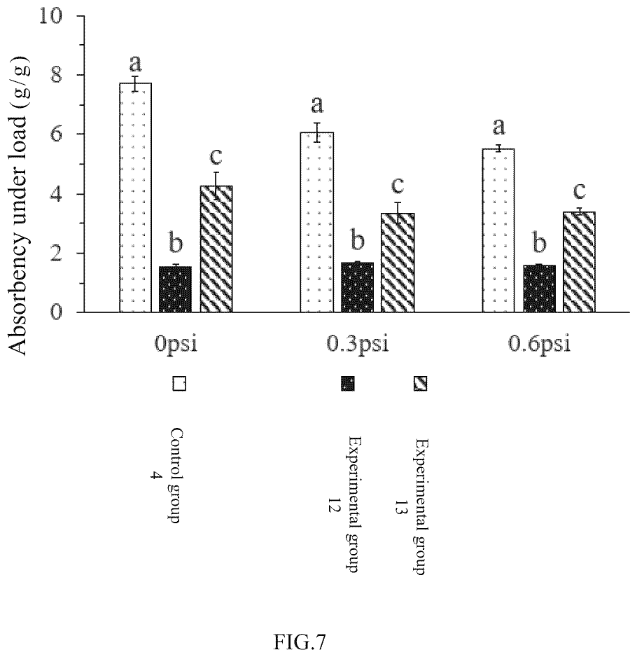

FIG. 7 shows that a saline-absorbing amount of the control group 4 under a load of 0 psi, a load of 0.3 psi, and a load of 0.6 psi is obviously greater than a saline-absorbing amount of the experimental group 12 and a saline-absorbing amount of the experimental group 13 under the load of 0 psi, the load of 0.3 psi, and the load of 0.6 psi. The saline-absorbing amount of the experimental group 12 under the load of 0 psi, the load of 0.3 psi, and the load of 0.6 psi is between 1 g/g and 2 g/g. The saline-absorbing amount of the experimental group 13 under the load of 0 psi, the load of 0.3 psi, and the load of 0.6 psi is between 3 g/g and 5 g/g. In other words, the saline-absorbing amount of the experimental group 13 under the load of 0 psi, the load of 0.3 psi, and the load of 0.6 psi is obviously greater than the saline-absorbing amount of the experimental group 12 under the load of 0 psi, the load of 0.3 psi, and the load of 0.6 psi. In addition, Table 1 shows ratios of different saline absorption rates of the control group 4 and ratios of different saline absorption rates of the experimental group 12, and ratios of different saline absorption rates of the experimental group 13 corresponding to 0.3 psi/0 psi and 0.6 psi/0 psi. The ratio of the saline absorption rate of the control group 4 corresponding to 0.3 psi/0 psi is 0.77 and the ratio of the saline absorption rate of the control group 4 corresponding to 0.6 psi/0 psi is 0.72, which represents that the saline-absorbing amount of the control group 4 shows a downward tendency with a stress of the load increasing. The ratio of the saline absorption rate of the experimental group 12 corresponding to 0.3 psi/0 psi is 1.05 and the ratio of the saline absorption rate of the experimental group 12 corresponding to 0.6 psi/0 psi is 1.06, which represents that a structural strength of the experimental group 12 is obviously greater than a structural strength of the control group 4 and the saline-absorbing amount of the experimental group 12 is not affected by the stress of the load. The ratio of the saline absorption rate of the experimental group 13 corresponding to 0.3 psi/0 psi is 0.81 and the ratio of the saline absorption rate of the experimental group 13 corresponding to 0.6 psi/0 psi is 0.87, which represents that a structural strength of the experimental group 13 is greater than the structural strength of the control group 4 and the saline-absorbing amount of the experimental group 13 increases with the stress of the load increasing. Therefore, the experimental group 12 and the experimental group 13 are suitable for hygiene products and a saline-absorbing function of the experimental group 12 and a saline-absorbing function of the experimental group 13 would not be affected during the user sitting on, lying on or being in contact with the hygiene product and the food packaging material which the experimental group 12 and the experimental group 13 are applied to.

TABLE 1
Different saline absorption rates of the control group 4,
different saline absorption rates of the experimental group
12, and different saline absorption rates of the experimental
group 13 corresponding 0.3 psi/0 psi and 0.6 psi/0 psi

| Item | 0.3 psi/0 psi | 0.6 psi/0 psi |
|---|---|---|
| Control group 4 | 0.77 ± 0.02b | 0.72 ± 0.01b |
| Experimental group 12 | 1.05 ± 0.01a | 1.06 ± 0.03a |
| Experimental group 13 | 0.81 ± 0.05b | 0.87 ± 0.05b |

### 7. a Release of Urea of the Experimental Group 12 and a Release of Urea of the Experimental Group 13 are Explored:

The current test is to simulate that the hygiene product (diaper) which the water-absorbing composite with the biodegradability is applied to contains urea after the hygiene product (diaper) is used. Through examining a urea-releasing amount of the water-absorbing composite with the biodegradability, a feasibility of an agricultural utility of the water-absorbing composite with the biodegradability could be estimated.

In the current test, the dried control group 4, the dried experimental group 12, and the dried experimental group 13 are respectively soaked in a 1.75% (w/w) urea solution. After the dried control group 4, the dried experimental group 12, and the dried experimental group 13 are respectively soaked in the 1.75% (w/w) urea solution for 24 hours, the control group 4, the experimental group 12, and the experimental group 13 are respectively weighed and then a urea-absorbing amount of the control group 4, a urea-absorbing amount of the experimental group 12, and a urea-absorbing amount of the experimental group 13 could be obtained. Subsequently, the control group 4, the experimental group 12, and the experimental group 13 are placed in an oven at 50° C. for 24 hours and then the dried control group 4, the dried experimental group 12, and the dried experimental group 13 which contain urea are respectively soaked in a deionized water of 20 ml placing in a plurality of beakers. After the control group 4, the experimental group 12, and the experimental group 13 are soaked in the deionized water for 30 minutes, all liquids in the beakers are respectively placed in 50 ml centrifuge tubes and liquid volumes are recorded. It is repeated that the dried control group 4, the dried experimental group 12, and the dried experimental group 13 which contain urea are respectively soaked in the deionized water of 20 ml in the beakers until a total soaking time reaches 4 hours. Subsequently, a 1.6% DMAB solution [DMAB of 1.6 g is dissolved in 95% ethanol of a small amount, then concentrated hydrochloric acid of 10 ml is added, and then 95% ethanol is added until a volume of the 1.6% DMAB solution is 100 ml] is formulated. Subsequently, a plurality of samples of the liquids in the beakers are respectively diluted by between 50 and 100 times. Subsequently, each of the diluted samples of 150 μl is added with the 1.6% DMAB solution of 150 μl and each of the diluted samples of 150 μl is well mixed with the 1.6% DMAB solution of 150 μl and a standard (urea) is added with the 1.6% DMAB solution of 150 μl and the standard (urea) is well mixed with the 1.6% DMAB solution of 150 μl. Subsequently, a light-absorbing value with a light of 425 nm is measured. According to a standard curve of urea, the light-absorbing value of the control group 4, the light-absorbing value of the experimental group 12, and the light-absorbing value of the experimental group 13 are substituted into a standard curve equation, thereby obtaining a urea-containing amount of the control group 4, a urea-containing amount of the experimental group 12, and a urea-containing amount of the experimental group 13.

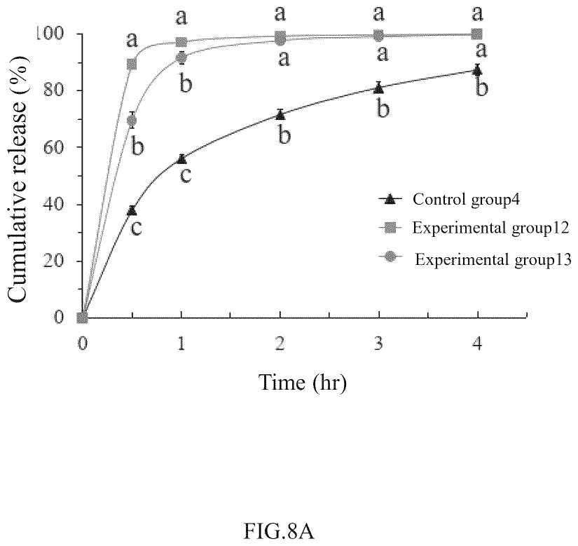

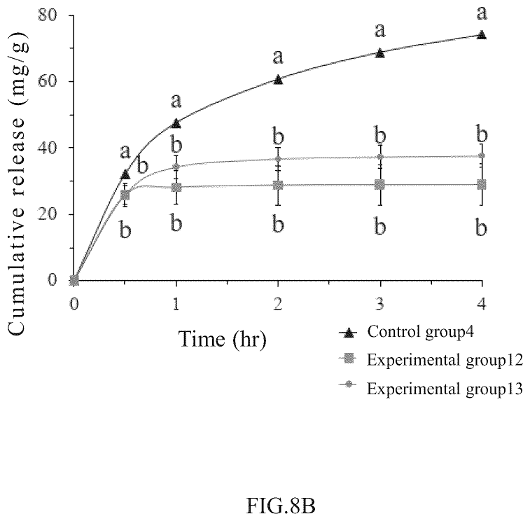

FIG. 8A shows urea of the control group 4, urea of the experimental group 12, and urea of the experimental group 13 are all released in direct proportion to the time. A urea-releasing rate of the experimental group 12 and a urea-releasing rate of the experimental group 13 are obviously greater than a urea-releasing rate of the control group 4. Compared with a urea-releasing amount of the experimental group 13, a urea-releasing amount of the experimental group 12 could be 100% within 1 hour. In addition, referring to FIG. 8B, a urea-releasing amount of the control group 4 within 0.5 hour is greater than the urea-releasing amount of the experimental group 12 and the urea-releasing amount of the experimental group 13, the urea-releasing amount of the control group 4 increases in direct proportion to the time, and urea-releasing amount of the experimental group 12 and the urea-releasing amount of the experimental group 13 show a flat tendency after 1 hour.

It could be presumed from the current test that the urea-containing amount of the control group 4 is greater and an osmotic pressure difference between the control group 4 and the water is greater, so that the urea-releasing amount of the control group 4 correspondingly increases but a release percentage of the control group 4 decreases. On the contrary, the urea-containing amount of the experimental group 12 and the urea-containing amount of the experimental group 13 are less than the urea-containing amount of the control group 4, so that the experimental group 12 and the experimental group 13 could finish releasing urea in a short time. Therefore, the experimental group 12 and the experimental group 13 could be effective carriers for releasing urea, so that the experimental group 12 and the experimental group 13 could be recycled and be applied to an agricultural fertilization.

### 8. a Biodegradability Test of the Experimental Group 12 and a Biodegradability Test of Experimental Group 13:

In the biodegradability test, a biodegradability of the control group 4 (sodium polyacrylate compound), a biodegradability of the experimental group 12, and a biodegradability of the experimental group 13 are explored. In the biodegradability test, a plurality of dry empty tea bags are first weighed (W1), then the control group 4, the experimental group 12, and the experimental group 13 are respectively placed in the dry empty tea bags, and then the dry tea bags are respectively weighed (W2). Subsequently, the empty tea bag, the tea bag of the control group 4, the tea bag of the experimental group 12, and the tea bag of the experimental group 13 are respectively placed in 50 ml centrifuge tubes which are respectively placed with a potting soil (organic potting soil, Sinon corporation) of 18 g containing a microbiota and are respectively added with the deionized water of 20 ml. Subsequently, the centrifuge tubes which are respectively placed with the control group 4, the experimental group 12, and the experimental group 13 are respectively placed in an incubator for culturing at 40° C. The biodegradability of the control group 4, the biodegradability of the experimental group 12, and the biodegradability of the experimental group 13 are observed on the 7th day, on the 14th day, and on the 21th day.

The empty tea bag, the tea bag of the control group 4, and the tea bag of the experimental group 12, and the tea bag of the experimental group 13 are moved out of the incubator on the 7th day, on the 14th day, and on the 21th day, then the tea bag of the control group 4, and the tea bag of the experimental group 12, and the tea bag of the experimental group 13 are moved out of the centrifuge tubes, and then are cleaned by using the deionized water to remove a soil residue on the tea bag of the control group 4, on the tea bag of the experimental group 12, and on the tea bag of the experimental group 13. Subsequently, after the empty tea bag, the tea bag of the control group 4, the tea bag of the experimental group 12, and the tea bag of the experimental group 13 are respectively soaked in the deionized water for 1 hour, the empty tea bag, the tea bag of the control group 4, the tea bag of the experimental group 12, and the tea bag of the experimental group 13 are respectively placed and dried in the oven at 40° C. for 24 hours. Finally, the dry empty tea bag, the dry tea bag placed with the control group 4, the dry tea bag placed with the experimental group 12, and the dry tea bag placed with the experimental group 13 are moved out of the oven and are weighed (W2′) and the biodegradability of the control group 4, the biodegradability of the experimental group 12, and the biodegradability of the experimental group 13 could be calculated by the following equation.

$$Biodegradability ( \% ) = \{ [ ( W 2 - W 1 ) - W {2}^{′} - W {1}^{′} ) ] / ( W 2 - W 1 ) \} * 100 \%$$

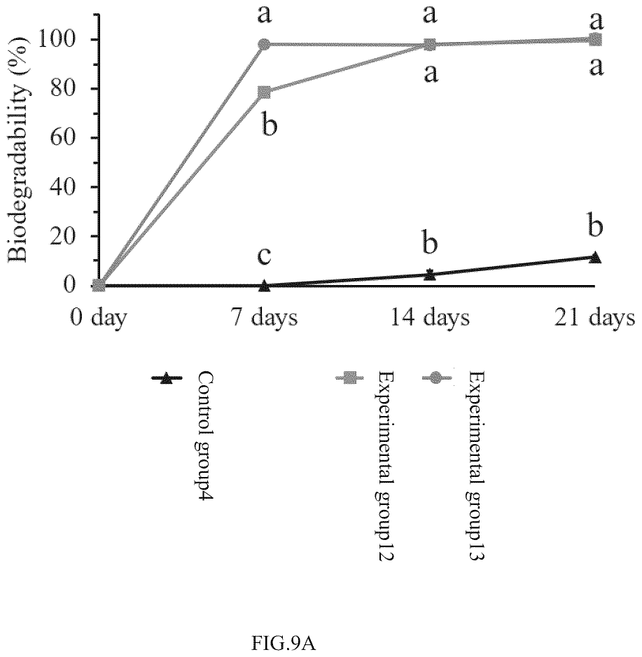

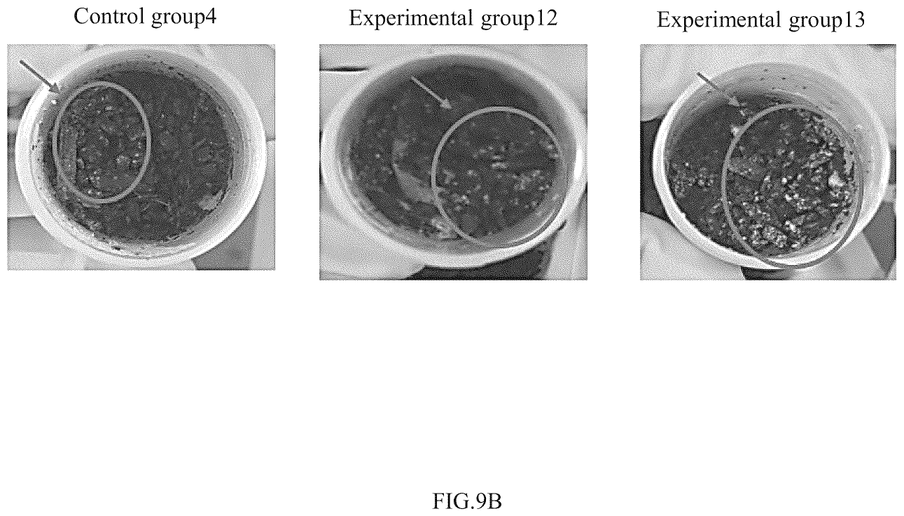

Referring to FIG. 9A, the biodegradability of the control group 4 is 0%, the biodegradability of the experimental group 12 is 78.60%, and the biodegradability of the experimental group 13 is 98.02% when the control group 4, the experimental group 12, and the experimental group 13 are cultured on the 7th day. The biodegradability of the control group 4 is 4.43%, the biodegradability of the experimental group 12 is 98.03%, and the biodegradability of the experimental group 13 is 98.03% when the control group 4, the experimental group 12, and the experimental group 13 are cultured on the 14th day. The biodegradability of the control group 4 is 11.51%, the biodegradability of the experimental group 12 is almost 100%, and the biodegradability of the experimental group 13 is almost 100% when the control group 4, the experimental group 12, and the experimental group 13 are cultured on the 21th day. FIG. 9B shows that a mold growth could be observed in the soil of the experimental group 12 and in the soil of the experimental group 13 and the mold growth does not exist in the soil of the control group 4 on the 7th day. It could be verified that the experimental group 12 and the experimental group 13 are more biodegradable than the control group 4 in the soil. Therefore, it could be known from the biodegradability test that the experimental group 12 and the experimental group 13 are indeed more biodegradable than the control group 4 in the soil, thereby reducing an environmental burden. Perhaps, because a structure of the experimental group 13 is looser than a structure of the experimental group 12, a difference between a biodegradability rate of the experimental group 12 and a biodegradability rate of the experimental group 13 exists. When the numerous moistures enter the structure of the experimental group 13, the structure of the experimental group 13 is prone to disintegrate, thereby accelerating the biodegradability rate of the experimental group 13. The structure of the experimental group 12 is dense, so that the structure of the experimental group 12 does not disintegrate easily when subjected to water. Therefore, the biodegradability rate of the experimental group 12 is slow and the experimental group 12 is suitable for the agricultural fertilization.

### 9. An Influence of the Water Evaporation of the Soil by the Experimental Group 12 and the Experimental Group 13 is Explored:

In the test of the influence of the moisture transpiration rate of the soil by the experimental group 12 and the experimental group 13, it is researched that an influence of the experimental group 12 and the experimental group 13 being applied to a soil irrigation on a water evaporation. The dried experimental group 12 of 0.23 g and the dried experimental group 13 of 0.23 g are respectively mixed with a sandy soil of 30 g. The control group 5 is the sandy soil of 30.23 g. Subsequently, a container containing the soil of the control group 5, a container containing the soil of the experimental group 12, and a container containing the soil of the experimental group 13 are respectively weighed (W1). After the deionized water of 15 g is added to the soil of the control group 5, the soil of the experimental group 12, and the soil of the experimental group 13, the soil of the control group 5, the soil of the experimental group 12, and the soil of the experimental group 13 are placed at room temperature for 1 hour, so that the soil of the control group 5, the soil of the experimental group 12, and the soil of the experimental group 13 could be saturated with the moisture and then are weighed (W2). Subsequently, the soil of the control group 5, the soil of the experimental group 12, and the soil of the experimental group 13 are respectively placed in the oven at 50° C. to undergo a water evaporation test. Subsequently, the soil of the control group 5, the soil of the experimental group 12, and the soil of the experimental group 13 are moved out of the oven and then are respectively weighed (W3) at the time of 2 hours, the time of 4 hours, and the time of 5 hours. Therefore, the water evaporation could be calculated by the following equation.

$$Water evaporation ( \% ) = \{ [ ( W 2 - W 1 ) - ( W 3 - W 1 ) ] / ( W 2 - W 1 ) \} * 100 \%$$

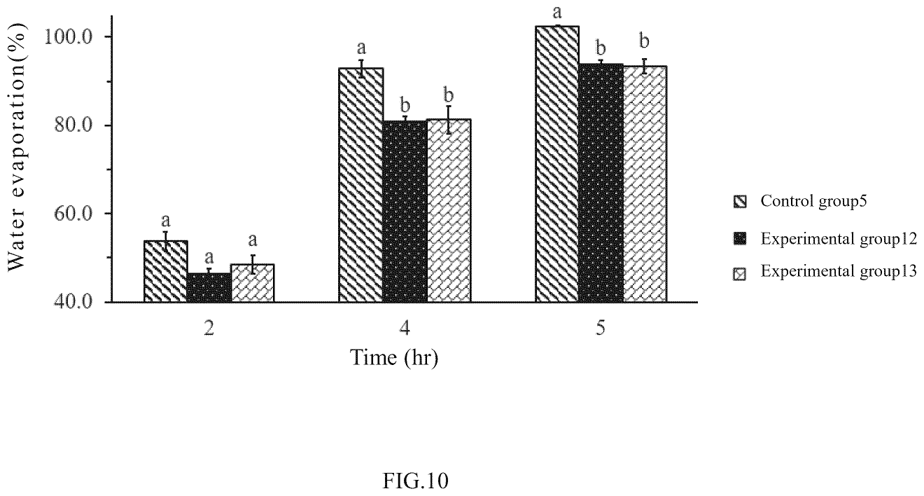

FIG. 10 shows that a water evaporation of the control group 5 is greater than a water evaporation of the experimental group 12 and a water evaporation of the experimental group 13 at the time of 2 hours, but a difference between the water evaporation of the control group 5 and the water evaporation of the experimental group 12 and a difference between the water evaporation of the control group 5 and the water evaporation of the experimental group 13 are not obvious. The water evaporation of the experimental group 12 and the water evaporation of the experimental group 13 are obviously less than the water evaporation of the control group 5 at the time of 4 hours and at the time of 5 hours. It could be presumed that the experimental group 12 and the experimental group 13 could reduce a water evaporation of the sandy soil and a water-holding effect on the soil of the experimental group 12 is similar to a water-holding effect on the soil of the experimental group 13, which represents that the experimental group 12 and the experimental group 13 in the dry state could effectively reduce the water evaporation to achieve the particular water-holding effect on the soil.

### 10. An Influence of the Experimental Group 12 and the Experimental Group 13 on a Plant Growth is Explored:

In the test for the influence of the experimental group 12 and the experimental group 13 on the plant growth, it is simulated that the experimental group 12 and the experimental group 13 applied to the hygiene product (diaper) are used and then the experimental group 12 and the experimental group 13 are recycled as fertilizer carriers for the plant growth. The plant used in the test for the influence of the experimental group 12 and the experimental group 13 on the plant growth is a radish which mainly grows with a taproot. In the test for the influence of the experimental group 12 and the experimental group 13 on the plant growth, a total length of a stem of the plant and the taproot of the plant is measured for estimation.

In the test for the influence of the experimental group 12 and the experimental group 13 on the plant growth on the first day, a plurality of icicle radish seeds is soaked in the water for about 3 hours, then are moved out of the water, and are placed on a moist tissue in the dark overnight. On the second day, after the icicle radish seeds bud, a plurality of containers are respectively added with the sandy soil of 60 g, the five budding icicle radish seeds, and the water of 15 ml and then the icicle radish seeds grow in the dark. When the icicle radish seeds leaves, the icicle radish seeds could be moved to a bright environment. On the 4th day, the dried experimental group 12 of 0.23 g and the dried experimental group 13 of 0.23 g are soaked in the 1.75% (w/w) urea solution for 24 hours. On the 5th day, the plants are divided into four groups containing the control group 5 (the plant grows without the water), the experimental group 12 with urea, the experimental group 13 with urea, and a control group (the plant begins to be added with the urea solution of 15 ml on the 5th day). After the plant of the control group 5, the plant of the control group, the plant of the experimental group 12, and the plant of the experimental group 13 grow for 9 days, the plant of the control group 5, the plant of the control group, the plant of the experimental group 12, and the plant of the experimental group 13 are moved out of the soil and the total length of each of the plants is measured (the total length of the stem and the longest root), so that the plant growth of the control group 5, the plant growth of the control group, the plant growth of the experimental group 12, and the plant growth of the experimental group 13 could be estimated.

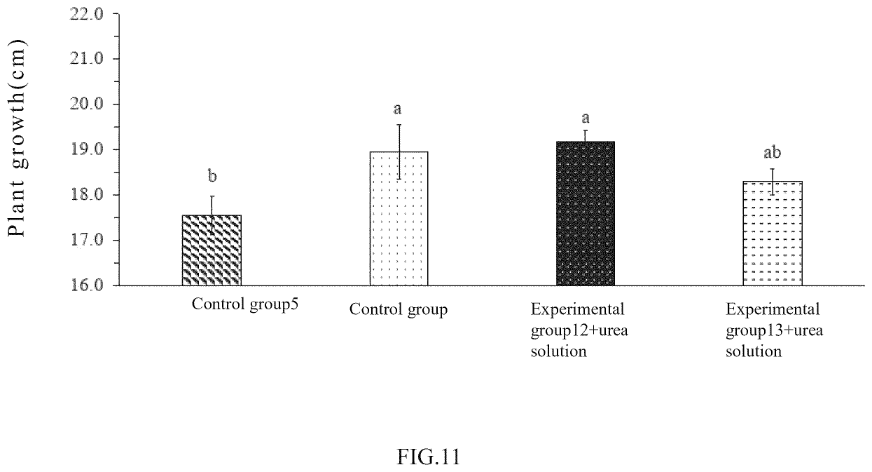

FIG. 11 shows that the plant growth of the control group, the plant growth of the experimental group 12, and the plant growth of the experimental group 13 are obviously greater than the plant growth of the control group 5 and the control group and the experimental group 12 could greatly promote the plant growth, which represents that the experimental group 12 and the experimental group 13 could slowly release urea absorbed by the experimental group 12 and the experimental group 13 in the soil to provide nutrition which the plants need to the plants. In addition, the experimental group 12 and the experimental group 13 could be recycled as the fertilizer carriers of the plants without a waste disposal.

With the aforementioned design, the water-absorbing composite with the biodegradability makes use of the egg white composition made from the egg whites and cooperates with the acylation reagent with the particular categories and the weights and the crosslinking reagent the particular categories and the weights, so that the water-absorbing composite with the biodegradability has the great water-absorbing function and the water-holding function. In the experimental group 12 and the experimental group 13, ethylenediaminetetraacetic dianhydride (EDTAD) or succinic anhydride (SA) cooperates with glycerol to modify a plurality of functional groups of the proteins of the egg white composition. Through the aforementioned tests, the experimental group 12 and the experimental group 13 show the great swelling capacity, the great water-holding capacity, the great structural stability, and the great biodegradability, could absorb urea, and could achieve the water-absorbing effect under the stress of the load, which represents that the experimental group 12 and the experimental group 13 could be applied to the hygiene products and the water-absorbing effect of the experimental group 12 and the water-absorbing effect of the experimental group 13 would not be affected during the user sitting on, lying on or being in contact with the hygiene product and the food packaging material which the experimental group 12 and the experimental group 13 are applied to. In the experimental group 10, ethylenediaminetetraacetic dianhydride (EDTAD) cooperates with N,N′-Methylenebisacrylamide (MBA) to be used, which shows the poor water holding capacity but the great water-absorbing effect. Therefore, because the water-absorbing composite with the biodegradability has a potential for substituting superabsorbent polymer (SAP) and could be recycled as the fertilizer carrier after the water-absorbing composite with the biodegradability is used, the water-absorbing composite with the biodegradability could be directly recycled, applied to the agricultural fertilization, and be naturally decomposed in the soil without the waste disposal, thereby promoting the plant growth.

In addition, the manufacturing method of the water-absorbing composite with the biodegradability undergoes many optimized steps to omit a preprocessing of the protein solution containing many and repeated steps of freezing and omit a heating process in step S2, so that a manufacturing time of the manufacturing method of the water-absorbing composite with the biodegradability could be greatly reduced without affecting the water-absorbing function of the water-absorbing composite with the biodegradability. Therefore, the manufacturing method of the water-absorbing composite with the biodegradability could achieve an effect of enhancing a manufacturing efficiency and reducing an energy dissipation.

It must be pointed out that the embodiments described above are only some preferred embodiments of the present invention. All equivalent structures which employ the concepts disclosed in this specification and the appended claims should fall within the scope of the present invention.

What is claimed is:

1. A water-absorbing composite with a biodegradability, comprising:
an egg white composition having a plurality of proteins, wherein a weight of the plurality of proteins accounts for between 3 wt % and 5 wt % of a weight of the water-absorbing composite with the biodegradability;
an acylation reagent reacting with a part of a plurality of amines of the plurality of proteins of the egg white composition, so that the egg white composition has a plurality of hydrophilic groups, wherein the acylation reagent is ethylenediaminetetraacetic dianhydride or succinic anhydride; a weight ratio of the acylation reagent to the plurality of proteins is between 0.05 g/g and 0.5 g/g; and
a crosslinking reagent bonding to another part of the plurality of amines of the plurality of proteins of the egg white composition or a part of a plurality of hydroxyl groups of the plurality of proteins of the egg white composition, wherein the crosslinking reagent is N,N′-methylenebisacrylamide or glycerol; a weight ratio of the crosslinking reagent to the plurality of proteins is between 0.1 g/g and 0.7 g/g.

2. The water-absorbing composite with the biodegradability as claimed in claim 1, wherein when the acylation reagent is ethylenediaminetetraacetic dianhydride and the crosslinking reagent is glycerol, the weight ratio of the acylation reagent to the plurality of proteins is between 0.15 g/g and 0.25 g/g and the weight ratio of the crosslinking reagent to the plurality of proteins is between 0.3 g/g and 0.7 g/g.

3. The water-absorbing composite with the biodegradability as claimed in claim 1, wherein when the acylation reagent is ethylenediaminetetraacetic dianhydride and the crosslinking reagent is N,N′-methylenebisacrylamide, the weight ratio of the acylation reagent to the plurality of proteins is between 0.15 g/g and 0.25 g/g and the weight ratio of the crosslinking reagent to the plurality of proteins is between 0.1 g/g and 0.16 g/g.

4. The water-absorbing composite with the biodegradability as claimed in claim 1, wherein when the acylation reagent is succinic anhydride and the crosslinking reagent is glycerol, the weight ratio of the acylation reagent to the plurality of proteins is between 0.05 g/g and 0.5 g/g and the weight ratio of the crosslinking reagent to the plurality of proteins is between 0.3 g/g and 0.7 g/g.

5. A manufacturing method of a water-absorbing composite with a biodegradability comprising the following steps:
step S1: providing a protein solution, wherein the protein solution has an egg white composition comprising a plurality of proteins; a weight of the plurality of proteins of the egg white composition accounts for between 3 wt % and 5 wt % of a weight of the protein solution;
step S2: adding an acylation reagent to the protein solution, mixing and modulating a pH value of the protein solution to be between 8 and 12, wherein the acylation reagent is ethylenediaminetetraacetic dianhydride or succinic anhydride; the acylation reagent reacts with a part of a plurality of amines of the plurality of proteins of the egg white composition, so that the egg white composition has a plurality of hydrophilic groups;
step S3: adding a crosslinking reagent to the protein solution, mixing, and then heating the crosslinking reagent and the protein solution, wherein the crosslinking reagent is N,N′-methylenebisacrylamide or glycerol; the crosslinking reagent bonds to another part of the plurality of amines of the plurality of proteins of the egg white composition or a part of a plurality of hydroxyl groups of the plurality of proteins of the egg white composition to form a protein-based hydrogel; and
step S4: drying the protein-based hydrogel containing the acylation reagent and the crosslinking reagent to form the dried protein-based hydrogel, thereby obtaining the water-absorbing composite with the biodegradability.

6. The manufacturing method of the water-absorbing composite with the biodegradability as claimed in claim 5, wherein step P1 is executed before step S1 and comprises providing an egg white liquid; the egg white liquid contains the egg white composition and is dried by freeze-drying, spray drying, or hot air drying, thereby obtaining an egg white powder; the egg white powder is dissolved in an aqueous solution to form the protein solution.

7. The manufacturing method of the water-absorbing composite with the biodegradability as claimed in claim 5, wherein a weight ratio of the acylation reagent added to the protein solution to the plurality of proteins is between 0.05 g/g and 0.5 g/g; a weight ratio of the crosslinking reagent added to the protein solution to the plurality of proteins is between 0.1 g/g and 0.7 g/g.

8. The manufacturing method of the water-absorbing composite with the biodegradability as claimed in claim 7, wherein when the acylation reagent is ethylenediaminetetraacetic dianhydride and the crosslinking reagent is glycerol, the weight ratio of the acylation reagent added to the protein solution to the plurality of proteins is between 0.15 g/g and 0.25 g/g and the weight ratio of the crosslinking reagent added to the protein solution to the plurality of proteins is between 0.3 g/g and 0.7 g/g.

9. The manufacturing method of the water-absorbing composite with the biodegradability as claimed in claim 7, wherein when the acylation reagent is ethylenediaminetetraacetic dianhydride and the crosslinking reagent is N,N′-methylenebisacrylamide, the weight ratio of the acylation reagent to the plurality of proteins is between 0.15 g/g and 0.25 g/g and the weight ratio of the crosslinking reagent to the plurality of proteins is between 0.1 g/g and 0.16 g/g.

10. The manufacturing method of the water-absorbing composite with the biodegradability as claimed in claim 7, wherein when the acylation reagent is succinic anhydride and the crosslinking reagent is glycerol, the weight ratio of the acylation reagent to the plurality of proteins is between 0.05 g/g and 0.5 g/g and the weight ratio of the crosslinking reagent to the plurality of proteins is between 0.3 g/g and 0.7 g/g.
